(19) United States
(12) Patent Application Publication
(10) Pub. No.: US 2016/0176537 A1
(43) Pub. Date: Jun. 23, 2016

(54) COMPONENT RACK CONSTRUCTION FOR USE IN AIRCRAFT

(71) Applicant: ODA Aviation Group, LLC, Garland, TX (US)

(72) Inventor: Luis A. Rodriguez, Garland, TX (US)

(21) Appl. No.: 14/574,659

(22) Filed: Dec. 18, 2014

(51) Int. Cl. B64D 43/00; B64D 11/00

(52) U.S. Cl. CPC B64D 43/00; B64D 11/00

(57) ABSTRACT

A component rack for use in an aircraft can include a stanchion having sides angularly offset relative to each other, with the sides widening at each opposite end of the sides, and a top fastened to one end of the stanchion sides. Another component rack for use in an aircraft can include a stanchion having sides orthogonal to each other, and a generally planar web which connects the sides to each other, the web being oriented forty-five degrees relative to each of the sides, and a shelf fastened to the stanchion web.

### BACKGROUND

This disclosure relates generally to equipment utilized and operations performed in conjunction with aircraft components and, in an example described below, more particularly provides a component rack construction for use in aircraft.

A component rack can be used to mount various types of components in an aircraft. For example, instruments, equipment, and other components can be installed in or on a rack in an aircraft. Therefore, it will be appreciated that improvements are continually needed in the art of constructing component racks for use in aircraft.

### BRIEF DESCRIPTION OF THE DRAWINGS

FIG. 1 is a representative isometric view of one example of a component rack assembly which can embody principles of this disclosure.

FIG. 2 is a representative elevational view of the component rack assembly.

FIG. 3 is a representative bottom view of the rack assembly.

FIG. 4 is a representative isometric view of a stanchion of the rack assembly.

FIG. 5 is a representative partially cross-sectional view of a shelf attachment portion of the rack assembly, taken along line 5-5 of FIG. 2.

### DETAILED DESCRIPTION

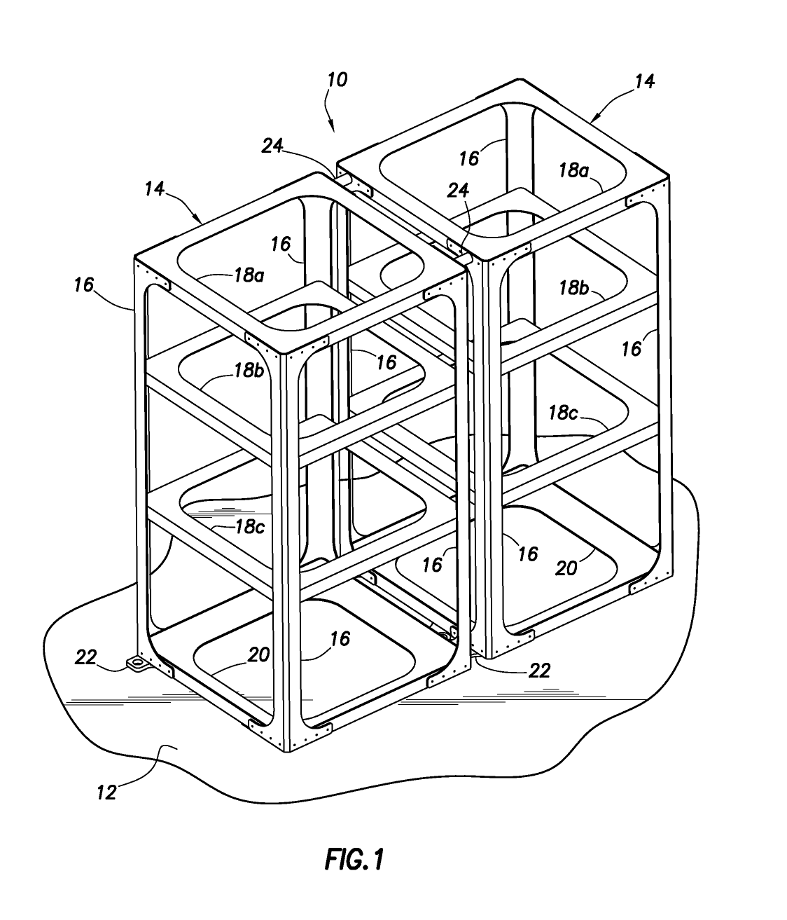

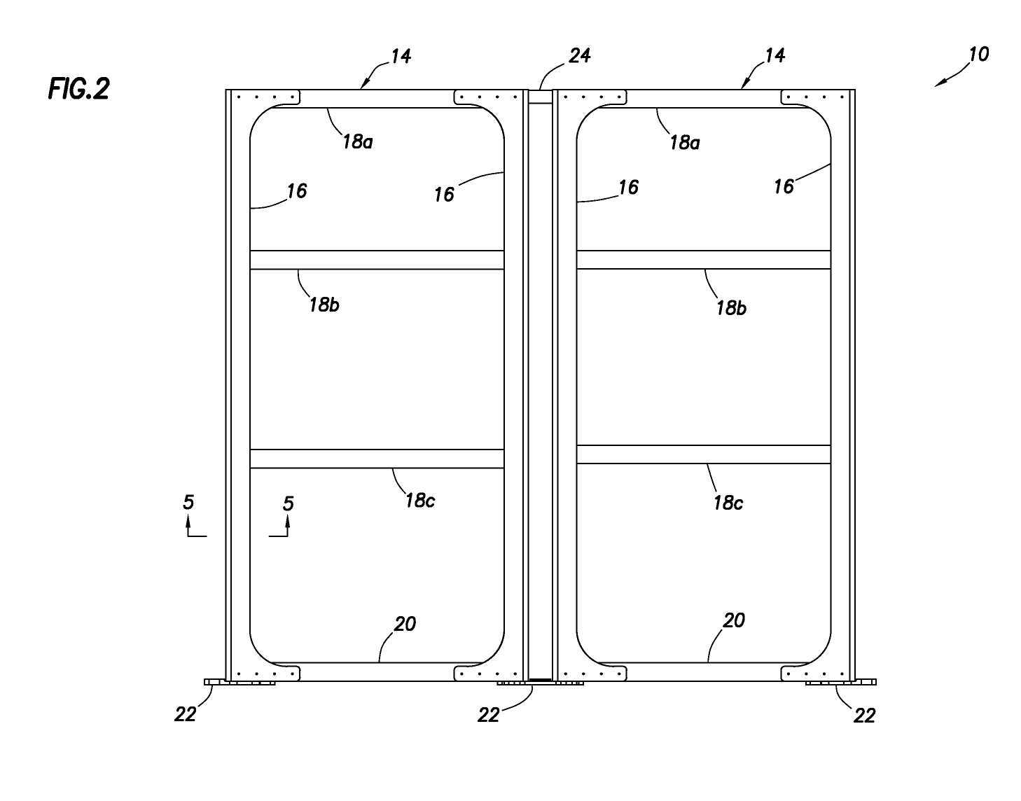

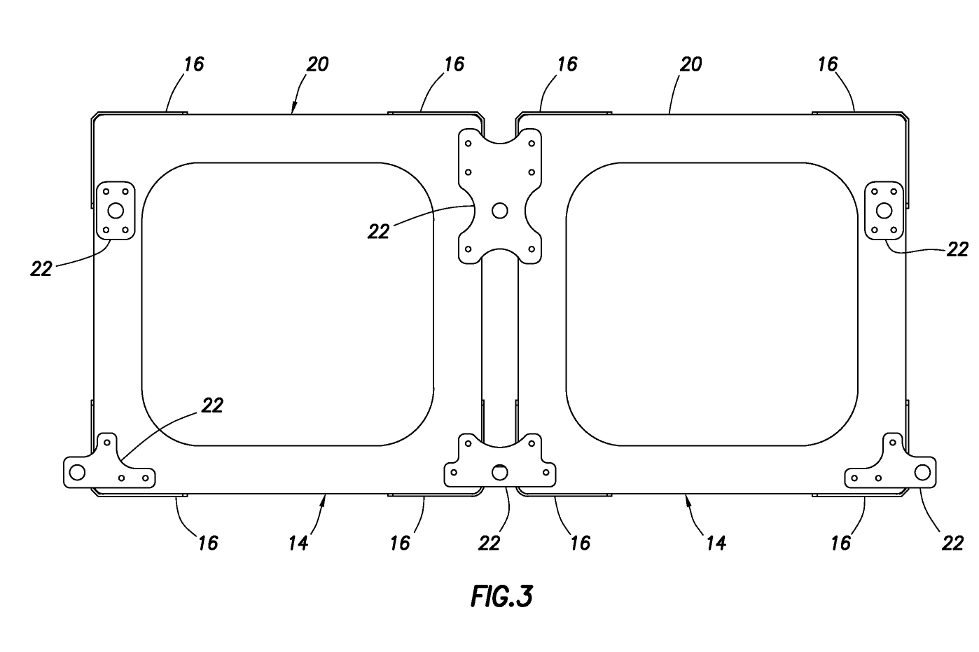

Representatively illustrated in FIGS. 1-3 is a component rack assembly 10 for use in an aircraft, and an associated method, which can embody principles of this disclosure. However, it should be clearly understood that the assembly 10 and method are merely one example of an application of the principles of this disclosure in practice, and a wide variety of other examples are possible. Therefore, the scope of this disclosure is not limited at all to the details of the assembly 10 and method described herein and/or depicted in the drawings.

In the FIG. 1 example, the rack assembly 10 is depicted as being attached to an aircraft surface 12 (such as, a floor, a lower surface of an enclosure, etc.). The surface 12 is beneath the rack assembly 10 in this example, but in other examples the rack assembly could be secured to other surfaces in addition to, or instead of, the surface 12.

As depicted in FIGS. 1-3, the rack assembly 10 includes two individual component racks 14 connected to each other. In other examples, other numbers of component racks (e.g., one or more) may be used individually, or combined together to form a rack assembly.

Each of the component racks 14 in the FIGS. 1-3 example includes four stanchions 16, a top 18a, two shelves 18b,c and a base 20. Other numbers of these components may be used, in keeping with the principles of this disclosure.

The bases 20 are secured to the aircraft surface 12 by means of brackets or fittings 22 and appropriate fasteners. Certain ones of the fittings 22 also serve to secure the racks 14 to each other at their bottoms. Spacers 24 and appropriate fasteners are used to secure the racks 14 to each other at their tops.

One particular advantage of the component rack 14 in the FIGS. 1-3 example is that only a few parts are used to provide a rigid structure suitable for housing components (e.g., equipment, instruments, articles, etc.) in an aircraft. In addition, the component rack 14 is relatively light weight and is convenient to assemble, configure and install.

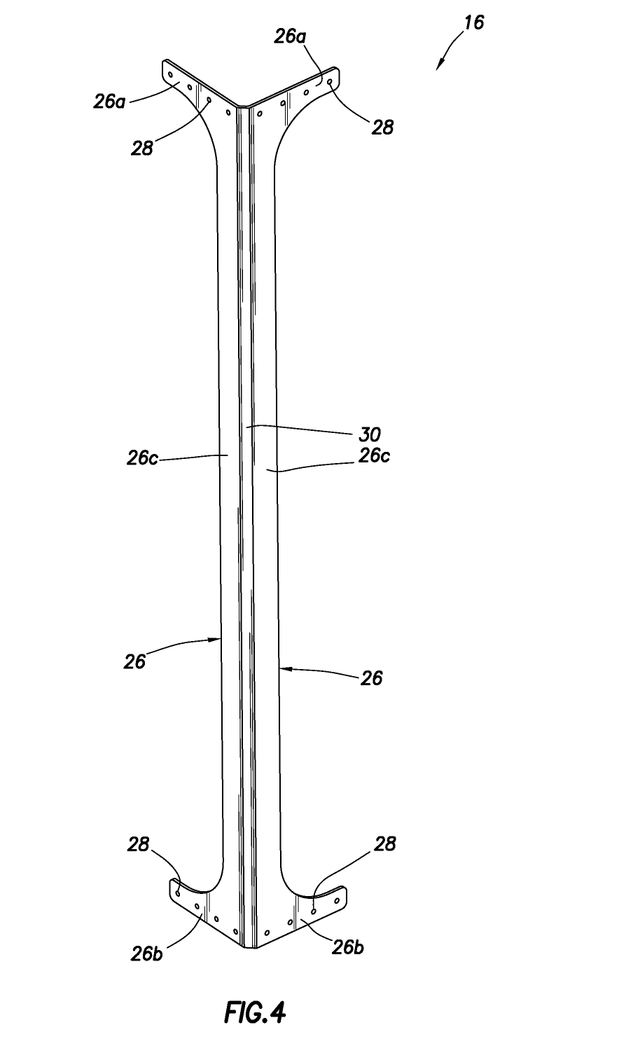

Referring additionally now to FIG. 4, one of the stanchions 16 is representatively illustrated apart from the remainder of the assembly 10. In this view, it may be seen that the stanchion 16 includes two sides 26 that are angularly offset from each other.

Specifically, in this example, the sides 26 are orthogonal to each other. However, in other examples, the sides 26 could be otherwise oriented relative to each other.

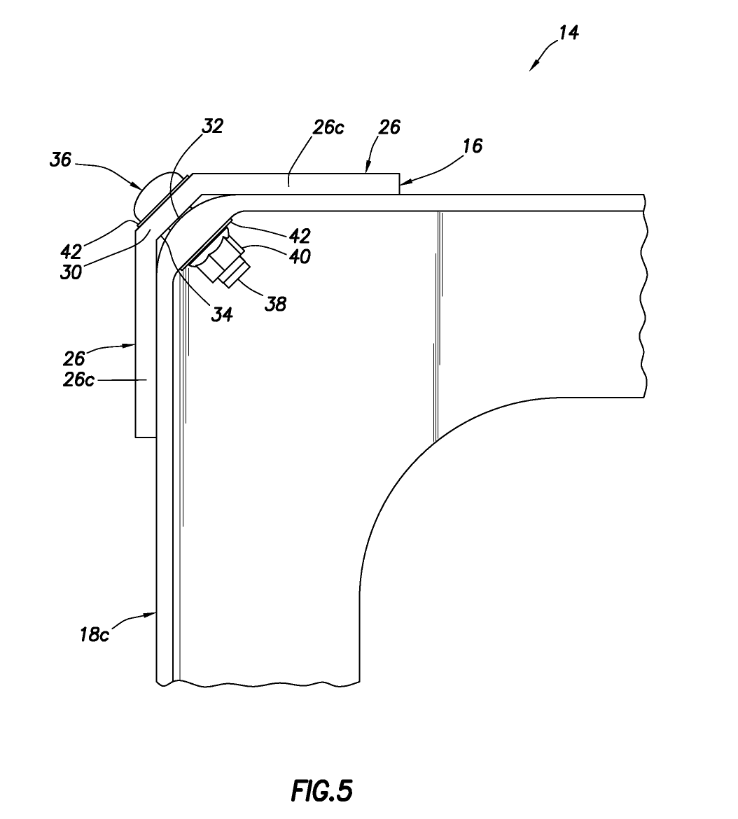

Each of the sides 26 is much wider at its opposite ends 26a,b, as compared to an intermediate portion 26c thereof. The widened ends 26a,b provide for securely attaching the stanchion 16 to the top 18a and the base 20, respectively, of the rack 14. For example, fasteners (not shown in FIG. 4, see FIG. 5) may be inserted through openings 28 in the stanchion ends 26a,b and similar openings in the top 18a and base 20.

One particular advantage of the widened ends 26a,b in this example is that relative rotation between the stanchion 16 and the top 18a and base 20 is more effectively resisted in each of three orthogonal axes. In addition, by integrally forming the widened ends 26a,b with the intermediate portion 26c, additional fasteners are not needed (for example, to secure separate gussets or braces to the stanchion 16, top 18a and base 20). However, the scope of this disclosure is not limited to integrally forming the ends 26a,b with the intermediate portion 26c of the stanchion 16.

The stanchion 16 in this example includes a web 30 that connects the sides 26 to each other. The web 30 is generally planar, and is oriented at forty-five degrees relative to each of the sides 26.

In this example, the stanchion 16 can be conveniently manufactured as a single structure from a composite material (a material made from two or more constituent components with significantly different physical or chemical properties that, when combined, produce the material with characteristics different from the individual components, with the individual components remaining separate and distinct within the composite material). For example, the composite material could include glass fiber, carbon fiber, polymer fiber, nano structures or other reinforcement in a polymer matrix. However, other types of composite materials, and non-composite materials, may be used to construct the stanchion 16 in keeping with the scope of this disclosure.

Referring additionally now to FIG. 5, a partially cross-sectional view of a portion of the rack 14 is representatively illustrated. In this view, it may be seen that a curved or rounded corner 32 of the shelf 18c is received in a generally concave receptacle 34 formed by the sides 26 and web 30 of the stanchion 16.

A fastener 36 secures the shelf corner 32 to the stanchion 16. In this example, the fastener 36 includes a bolt 38, a nut 40 and washers 42, but in other examples, other types of fasteners (such as, rivets, screws, etc.) or fasteners having other numbers or combinations of components may be used, in keeping with the scope of this disclosure.

Note that only a single fastener 36 is used in this example to secure the shelf 18c to each stanchion 16 of the rack 14. In addition, the fastener 36 extends through only the stanchion 16 and the shelf corner 32. When the fastener 36 is used to secure the ends 26a,b to the top 18a and base 20, the fastener similarly extends only through the respective stanchion end and the top or base.

It may now be fully appreciated that the above disclosure provides significant advancements to the art of constructing component racks for use in aircraft. In examples described above, the rack 14 is relatively light in weight, includes relatively few components and is convenient to assemble and install in an aircraft.

More specifically, a component rack 14 for use in an aircraft is provided to the art by the above disclosure. In one example, the component rack 14 can comprise at least one stanchion 16 having sides 26 angularly offset relative to each other. The sides 26 widen at each of first and second ends 26a,b of the sides. A top 18a is fastened to the first ends 26a of the stanchion sides 26.

The component rack 14 can also comprise a base 20 fastened to the second ends 26b of the stanchion sides 26. The base 20 may be secured to a surface 12 of the aircraft.

A fastener 36 can be used to secure the top 18a to one of the first ends 26a of the stanchion sides 26. In this example, only the top 18a and the first end 26a of the stanchion sides 26 are secured to each other by the fastener 36. The fastener 36 may extend through only the top 18a and the first end 26a of the stanchion sides 26.

The stanchion 16 can be made entirely of a composite material. The stanchion sides 26 may be orthogonal to each other, and a generally planar web 30 may connect the sides to each other, with the web being oriented forty-five degrees relative to each of the sides.

A fastener 36 can be used to secure the web 30 to a shelf 18b,c, with only the web and the second shelf being secured to each other by the fastener. The fastener 36 may extend through only the web 30 and the shelf 18b,c.

A curved corner 32 of the shelf 18b,c may be received in a receptacle 34 formed by the sides 26 and the web 30 of the stanchion 16. A fastener 36 can extend through the curved corner 32.

Also described above is a component rack 14 for use in an aircraft, the component rack comprising at least one stanchion 16 having sides 26 orthogonal to each other, and a generally planar web 30 which connects the sides to each other, the web being oriented forty-five degrees relative to each of the sides; and a shelf 18b,c fastened to the stanchion web 30.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A component rack for use in an aircraft, the component rack comprising:
at least one stanchion having sides angularly offset relative to each other, wherein the sides widen at each of first and second ends of the sides; and
a top fastened to the first ends of the stanchion sides.

2. The component rack of claim 1, further comprising a base fastened to the second ends of the stanchion sides.

3. The component rack of claim 2, wherein the base is secured to a surface of the aircraft.

4. The component rack of claim 1, wherein a fastener secures the top to one of the first ends of the stanchion sides, and wherein only the top and the first end of the stanchion sides are secured to each other by the fastener.

5. The component rack of claim 1, wherein a fastener secures the top to one of the first ends of the stanchion sides, and wherein the fastener extends through only the top and the first end of the stanchion sides.

6. The component rack of claim 1, wherein the stanchion is made entirely of a composite material.

7. The component rack of claim 1, wherein the stanchion sides are orthogonal to each other, and wherein the stanchion further has a generally planar web which connects the sides to each other, the web being oriented forty-five degrees relative to each of the sides.

8. The component rack of claim 7, wherein a fastener secures the web to a shelf, and wherein only the web and the shelf are secured to each other by the fastener.

9. The component rack of claim 7, wherein a fastener secures the web to a shelf, and wherein the fastener extends through only the web and the shelf.

10. The component rack of claim 7, wherein a curved corner of a shelf is received in a receptacle formed by the sides and the web of the stanchion, and wherein a fastener extends through the curved corner.

11. A component rack for use in an aircraft, the component rack comprising:
at least one stanchion having sides orthogonal to each other, and a generally planar web which connects the sides to each other, the web being oriented forty-five degrees relative to each of the sides; and
a shelf fastened to the stanchion web.

12. The component rack of claim 11, wherein a fastener secures the web to the shelf, and wherein only the web and the shelf are secured to each other by the fastener.

13. The component rack of claim 11, wherein a fastener secures the web to the shelf, and wherein the fastener extends through only the web and the shelf.

14. The component rack of claim 11, wherein a curved corner of the shelf is received in a receptacle formed by the sides and the web of the stanchion, and wherein a fastener extends through the curved corner.

15. The component rack of claim 11, wherein the sides widen at each of first and second ends of the sides, and wherein a top is fastened to the first ends of the stanchion sides.

16. The component rack of claim 15, further comprising a base fastened to the second ends of the stanchion sides.

17. The component rack of claim 16, wherein the base is secured to a surface of the aircraft.

18. The component rack of claim 15, wherein a fastener secures a top to one of the first ends of the stanchion sides, and wherein only the top and the first end of the stanchion sides are secured to each other by the fastener.

19. The component rack of claim 15, wherein a fastener secures a top to one of the first ends of the stanchion sides, and wherein the fastener extends through only the top and the first end of the stanchion sides.

20. The component rack of claim 11, wherein the stanchion is made entirely of a composite material.
